(19) United States
(12) Patent Application Publication
(10) Pub. No.: US 2025/0013442 A1
(43) Pub. Date: Jan. 9, 2025

(54) FIXED FUNCTION SHARED ACCELERATOR

(71) Applicant: Trustees of Tufts College, Medford, MA (US)

(72) Inventors: Mark Hempstead, Medford, MA (US); Parnian Mokri, Medford, MA (US)

(21) Appl. No.: 18/766,092

(22) Filed: Jul. 8, 2024

Related U.S. Application Data
(60) Provisional application No. 63/512,517, filed on Jul. 7, 2023.

(51) Int. Cl. G06F 8/41; G06F 8/73

(52) U.S. Cl. CPC G06F 8/42; G06F 8/73

(57) ABSTRACT

Systems and methods for generating fixed function shared accelerators (FFSAs) implement and/or comprise operations of receiving source code, the source code indicating a plurality of workloads to be performed by an electronic circuit; generating a plurality of abstract syntax trees (ASTs) based on the source code, wherein respective ones of the plurality of ASTs include a plurality of nodes corresponding to function instructions; generating a plurality of fingerprinting vectors corresponding to the plurality of ASTs, wherein respective ones of the plurality of fingerprinting vectors encode at least one of a number of nodes, a number of edges, a density, a computation intensity, an operands percentage, a control, or a data dependency; and providing the plurality of fingerprinting vectors to a machine learning (ML) model, wherein the ML model is configured to predict similarities between different ones of the plurality of workloads and to output at least one candidate FFSA.

### CROSS-REFERENCE TO RELATED APPLICATIONS

This application is based on, claims priority to, and incorporates herein by reference in its entirety, U.S. Provisional Application Ser. No. 63/512,517, filed Jul. 7, 2023.

### STATEMENT REGARDING FEDERALLY SPONSORED RESEARCH OR DEVELOPMENT

This invention was made with government support under grant number 1619816 awarded by the National Science Foundation. The government has certain rights in the invention.

### TECHNICAL FIELD

This disclosure relates to the field of integrated circuits. More particularly, this disclosure relates to systems and methods to identify/fingerprint shared accelerator kernels for software acceleration, for example using machine learning techniques.

### BACKGROUND

Embedded systems include many special-purpose heterogeneous accelerators, each designed to execute a single software kernel. One way to simplify and improve design efficiency is to increase the number of workloads covered by hardware accelerators. Comparative examples have introduced complex and time-consuming approaches based on graph-isomorphism to find similarities between workloads from different domains and design hardware modules that run multiple workloads. Graph-isomorphism is a class NP-intermediate problem that requires about nine computational months to find pair-wise isomorphism between subgraphs of hundreds of nodes, and up to four computational years to discover all isomorphic subgraphs among larger workload suites.

### SUMMARY

The present disclosure provides for an early-stage lightweight fingerprinting methodology. Systems and methods as described herein encapsulate a kernel's static and dynamic behavior. The disclosed methodology uses, in examples, machine learning methods to find acceleration candidates among different domains and finds all isomorphism candidate, further increasing the coverage of shared accelerators.

According to one aspect of the present disclosure, a method of generating fixed function shared accelerators (FFSAs) is provided. The method comprises receiving source code, the source code indicating a plurality of workloads to be performed by an electronic circuit; generating a plurality of abstract syntax trees (ASTs) based on the source code, wherein respective ones of the plurality of ASTs include a plurality of nodes corresponding to function instructions; generating a plurality of fingerprinting vectors corresponding to the plurality of ASTs, wherein respective ones of the plurality of fingerprinting vectors encode at least one of a number of nodes, a number of edges, a density, a computation intensity, an operands percentage, a control, or a data dependency; and providing the plurality of fingerprinting vectors to a machine learning (ML) model, wherein the ML model is configured to predict similarities between different ones of the plurality of workloads and to output at least one candidate FFSA.

According to another aspect of the present disclosure, a system for generating fixed function shared accelerators (FFSAs) is provided. The system comprises at least one electronic processor; and a memory operatively connected to the at least one electronic processor, the memory storing instructions that, when executed by the at least one electronic processor, cause the system to perform operations including: receiving source code, the source code indicating a plurality of workloads to be performed by an electronic circuit, generating a plurality of abstract syntax trees (ASTs) based on the source code, wherein respective ones of the plurality of ASTs include a plurality of nodes correspond to function instructions, generating a plurality of fingerprinting vectors corresponding to the plurality of ASTs, wherein respective ones of the plurality of fingerprinting vectors encode at least one of a number of nodes, a number of edges, a density, a computation intensity, an operands percentage, a control, or a data dependency, and providing the plurality of fingerprinting vectors to a machine learning (ML) model, wherein the ML model is configured to predict similarities between different ones of the plurality of workloads and to output at least one candidate FFSA.

### BRIEF DESCRIPTION OF THE DRAWINGS

FIG. 1 illustrates an example accelerator architecture according to a comparative example.

FIG. 2 illustrates an example accelerator architecture according to various aspects of the present disclosure.

FIG. 3 illustrates an example accelerator architecture according to various aspects of the present disclosure.

FIG. 4 illustrates a comparison between a comparative example and various aspects of the present disclosure.

FIG. 5 illustrates a graphical representation of an example syntax tree according to various aspects of the present disclosure.

FIG. 6 illustrates a process flow of an example fingerprinting method according to various aspects of the present disclosure.

FIG. 7 illustrates a representation of an example machine learning implementation according to various aspects of the present disclosure.

FIG. 8 illustrates a graph of accuracy vs. model memory for an example implementation according to various aspects of the present disclosure.

FIG. 9A illustrates a graph of resource usage according to various aspects of the present disclosure.

FIG. 9B illustrates a graph of resource usage according to various aspects of the present disclosure.

FIG. 9C illustrates a graph of resource usage according to various aspects of the present disclosure.

FIG. 10 illustrates a comparison between a comparative example and various aspects of the present disclosure.

FIG. 11A illustrates a graph of resource usage according to various aspects of the present disclosure.

FIG. 11B illustrates a graph of resource usage according to various aspects of the present disclosure.

FIG. 12 illustrates an example of conditional statements and their effect.

FIG. 13 illustrates a process flow of an example method of generating shared accelerators according to various aspects of the present disclosure.

FIG. 14 illustrates a schematic of an example system for generating shared accelerators according to various aspects of the present disclosure.

FIG. 15A illustrates a comparison of computational time and accuracy.

FIG. 15B illustrates a comparison of computational time and accuracy.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details.

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Application-specific accelerators consume a large portion of system area on modern systems-on-a-chip (SoCs), but still do not cover the full spectrum of workloads that a machine encounters throughout its operational lifespan. It is estimated that many modern chips have dozens of loosely coupled accelerators consuming over 40% of chip area. The exponential use of accelerators on chips has given rise to fears that this level of specialization will hit a hard limit, referred to as the “accelerator wall.”

In view of this, a design style referred to as a Fixed-Function Shared Accelerator (FFSA) is presented. FFSAs are application-specific hardware that can combine running multiple workloads that are functionally and structurally similar. This is distinct from comparative examples such as a coarse-grained reconfigurable array (CGRA) and more general purpose processors such as graphics processing units (GPUs) and artificial intelligence (AI) accelerators. The present disclosure presents efficient implementations that will exhibit an FFSA latency that is comparable to that of the dedicated algorithms and shared accelerator hardware resources, and less than the sum of the dedicated accelerators.

As used herein, an FFSA is a shared accelerator that combines two or more fixed-function dedicated hardware accelerators into a single accelerator with a shared interface capable of executing two or more fixed tasks. The FFSA provides improved efficiency arising, for example, from the identification of common hardware kernels between each dedicated hardware accelerator and the replacement of the dedicated accelerators. These duplicated shared resources can then be removed.

The systems and methods described herein were evaluated for software kernels found in many commercial applications using MachSuite benchmarks. MachSuite includes a set of benchmarks based on a number of publications from conferences in the field, used to gauge which applications are most often used to develop accelerators in both industry and academia. It includes nineteen workloads, selected from applications that are used very differently and that are core to a specific type of computation. For example, “MD/KNN” is used for molecular dynamics computations. Matrix multiplication is widely used in a range of applications from network theory, solutions of linear systems of equations, transformation of coordinate systems, population modeling, and image and signal processing. “Stencil2D” and “Stencil3D” are used in stencil computation, which is a cornerstone of many scientific fields that rely on partial differential equations such as physics, geometry, and calculus. “Viterbi” is an implementation of Hidden Markov models based on a dynamic programming method. Hidden Markov models are a widely used stochastic model with applications ranging from information coding to speech recognition to bioinformatics. “Radix sort” is used in both fixed and floating point and sparse computation, for example in GPUs.

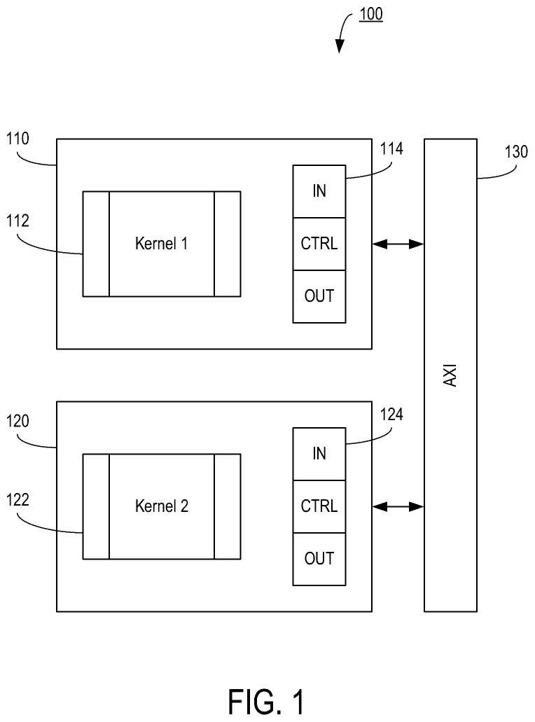

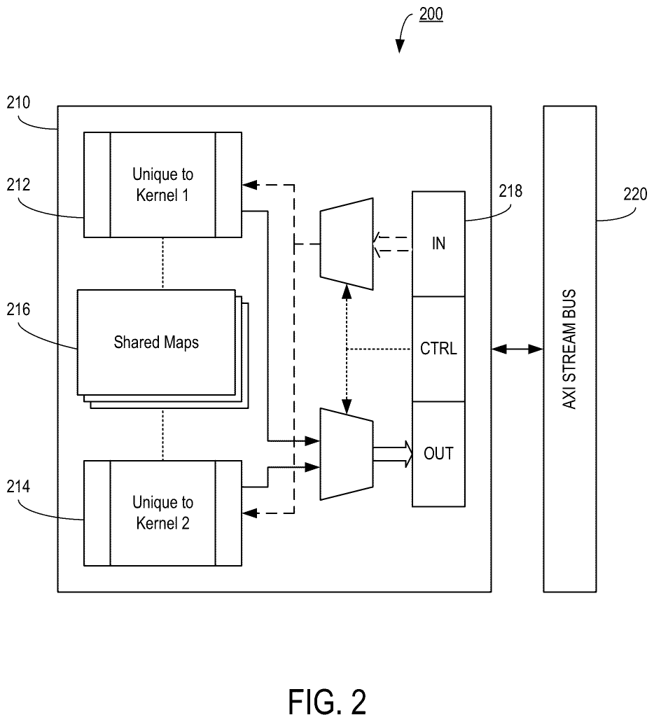

FIGS. 1 and 2 illustrate the transition from dedicated accelerators to an FFSA. FIG. 1 shows a first architecture 100 that implements a first dedicated accelerator 110 and a second dedicated accelerator 120. The first dedicated accelerator 110 includes a hardware kernel implementing a first dedicated hardware accelerator 112 and a first set of control resources 114 to implement input, output, and control functions. The second dedicated accelerator 120 includes a hardware kernel implementing a second dedicated hardware accelerator 122 and a second set of control resources 124 to implement input, output, and control functions. The hardware kernels may correspond to, in an example, two MachSuite benchmarks such as Stencil2D and Viterbi. Both the first dedicated accelerator 110 and the second dedicated accelerator 120 are separately in communication with a bus 130.

FIG. 2 shows a second architecture 200 that implements an FFSA 210. The FFSA 210 includes a first dedicated hardware kernel 212 corresponding to hardware that is unique to the first kernel, a second hardware kernel 214 corresponding to hardware that is unique to the second kernel, and a set of shared hardware resources 216 corresponding to hardware that is common to the first and second kernels. In the example where the hardware kernels correspond to the Stencil2D and Viterbi MachSuite benchmarks, the shared hardware resources 216 may include a loop with array multiplication and accumulation. The common hardware may be identified from the applications' source code using an automated fingerprinting method that will be described in more detail below. The FFSA 210 includes a shared set of control resources 218 to implement input, output, and control functions. The FFSA 210 is in communication with a bus 220.

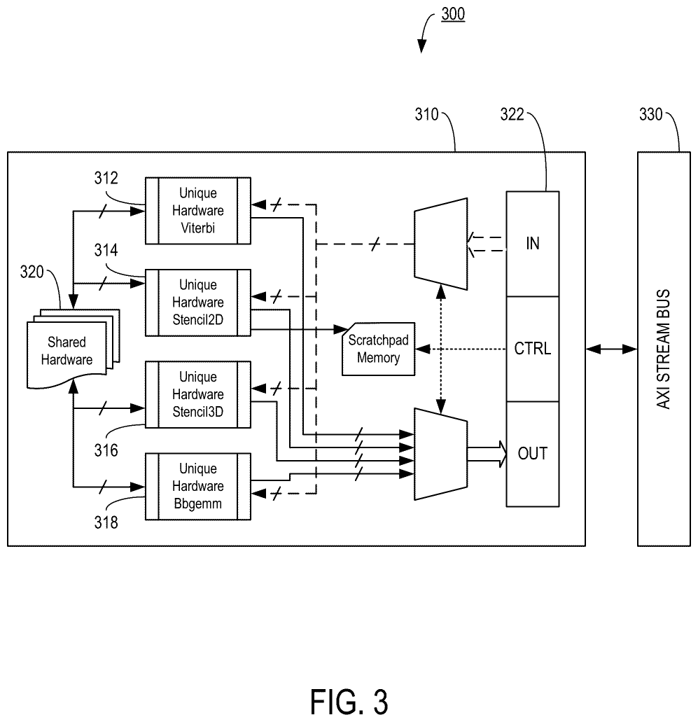

An FFSA in accordance with the present disclosure is not limited running two benchmarks (FFSA2) as shown in FIG. 2. In general, any number of benchmarks may be incorporated into an FFSA using the systems and methods set forth herein. For example, FIG. 3 illustrates an FFSA architecture 300 that runs four benchmarks (FFSA4). Thus, the FFSA 310 includes a first dedicated hardware kernel 312 corresponding to hardware that is unique to the first kernel, a second hardware kernel 314 corresponding to hardware that is unique to the second kernel, a third dedicated hardware kernel 316 corresponding to hardware that is unique to the third kernel, a fourth hardware kernel 318 corresponding to hardware that is unique to the fourth kernel, and a set of shared hardware resources 320 corresponding to hardware that is common to the all four kernels. In this example, the first through fourth dedicated hardware kernels 312-318 correspond to the Viterbi, Stencil2D, Stencil3D, and Bbgemm MachSuite benchmarks, respectively. The FFSA 310 further includes a shared set of control resources 322 to implement input, output, and control functions, and is in communication with a bus 330.

In a comparative example, the fingerprinting methodology used to distinguish between the shared kernel that covers a portion of all workloads and the much smaller unique dedicated accelerators for the portion of these workloads not covered by the shared kernel may be implemented before high-level synthesis is used. The fingerprinting methodology represents a workload as a transformed Abstract Syntax Tree (AST) and automatically detects shared kernels in pairs of workloads using a sub-graph isomorphism. The sub-graph isomorphism is used to look for portions of a workload that match portions of other workloads. As noted above, however, this is a class NP-intermediate problem that results in high computation costs even for small workloads. In one example, it takes approximately nine months of computational time to find pair-wise isomorphism across all MachSuite benchmarks.

It is not straightforward to utilize machine learning (ML) methods to find shared accelerators. Among the challenges presented is that one must first constrain the problem so that it is tractable for ML. The present disclosure presents systems and methods to take unstructured programs and formulate a clear ML problem with a feature set and labels. The methodology presented herein quickly finds potential positive cases (matching hardware) with a negligible false negative rate. More precise methods may then be used to evaluate the candidates. This approach, including extracting a compact vector representation and either supervised or unsupervised ML methods, reduces the processing time by three orders of magnitude and can have an accuracy of 97% compared to the ground truth of isomorphism results. The methodology set forth herein also finds all of the potential isomorphic cases at the same time, which enables the discovery of FFSAs that cover more than two workloads.

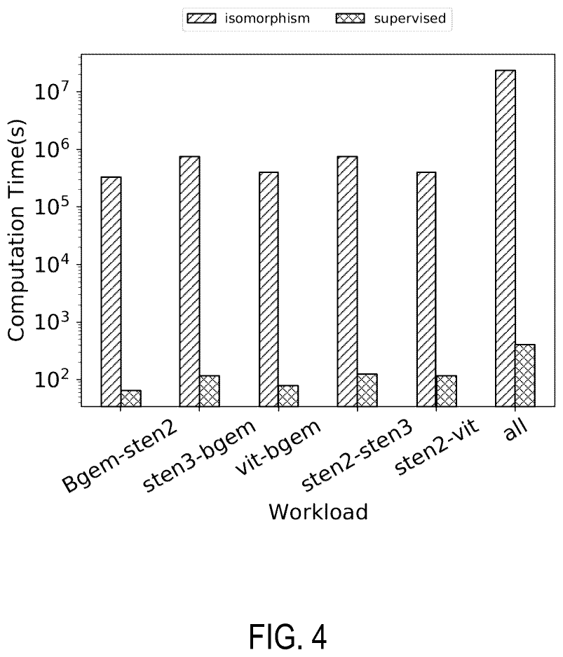

FIG. 4 illustrates a graph of the effect of the systems and methods set forth herein as compared to the comparative isomorphism results. In FIG. 4, the computational time to find all acceleration candidates is shown along the vertical axis on a logarithm scale. As can be seen from FIG. 4, the supervised ML methods described in more detail below provide speed increase of three orders of magnitude (10³) for most of the workloads, and a total speed increase of four orders of magnitude (10⁴) for all workloads.

The present disclosure thus sets forth a workload vector representation fingerprint and encapsulates features that predict the similarity of synthesized workloads; presents an ML methodology that reduces the exploration time and associated computational burden from months to minutes; provides a study of different fingerprint ML models through supervised classification using Random Forest for both efficiency and accuracy, and extends the comparative approaches by finding FFSAs across more than two workloads and among workloads where sub-graph isomorphism fails.

Expressing Workloads with Fingerprints

To enable practical implementations of the FFSA, a fast, easy-to-search, and compact workload representation is developed to find structural similarities between multiple workloads. The fingerprint and features extracted are described, and the selection of AST features and the encoding of specific types of data dependencies.

ASTs represent source code as a tree where nodes are instructions and edges represent the hierarchy of program instructions. An AST is a static representation of an application produced after parsing source code. in one example, using the Clang compiler, ASTs are produced in two formats: a simple tree with minimum information, and a text file with a complete list of attributes. Information such as the type of operand (integer or float) can be extracted explicitly from ASTs. Moreover, the structure of ASTs provides insight into a program's hierarchy and program flow.

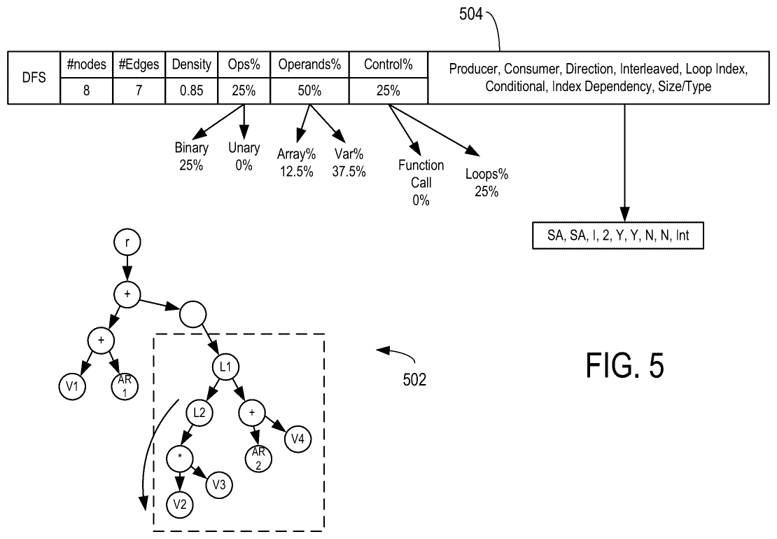

AST representation is a way to find matches between kernels, and has seen use in plagiarism detection, design automation, and EDA communities. FIG. 5 illustrates a graphical representation of an AST 502 and its fingerprint representation vector 504. The clustered AST and its characteristic as well as the data dependency vector, which is the input to the fingerprinting methodology, are shown. Each AST 502 starts with a node representing the beginning of the function. The leftmost node in each AST is the first instruction of each compound statement, and the node to the right shows the next instruction. This invariant ensures that a breadth-first traversal of the AST 502 is equivalent to a sequential walk-through of the program. The number of children of each node estimates the number of instructions that can be seen from that node, and children of nodes that represent binary and unary operations signify their operations. Mapping from a node in an AST representation to a line in source code provides the benefit of being deterministic, unlike comparative representations. In addition, because of its tree structure, fingerprints of each AST subtree can be quickly extracted, easily searched, and clustered by ML tools.

The fingerprinting methodology for detecting FFSAs of the present disclosure was designed in light of the following objectives: that it be compact and easy to evaluate, that it capture key characteristics, that it maintains AST's structure for code reconstruction, and that it includes hardware-specific concerns (data dependencies) that are not detected in isomorphism.

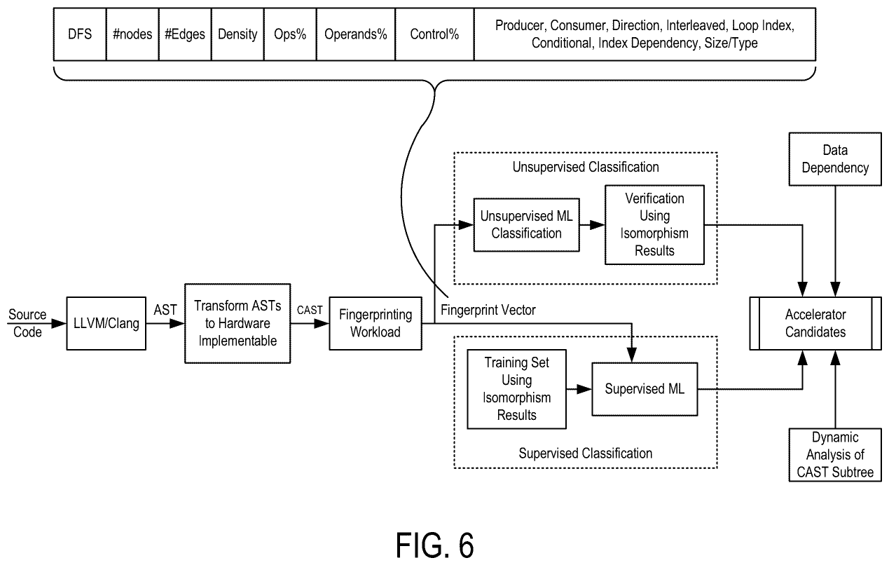

FIG. 6 illustrates one example of a fingerprinting methodology in accordance with the present disclosure, and shows both the CAD methodology and the fingerprint definition. Each AST is broken into its Depth-First walks because each DFS walk of an AST recreates the source code. For example, the AST shown in FIG. 5 has eight DFS subtrees, with the highlighted subtree as one of the “best” candidates for hardware implementation. All of the DFS subtrees are saved separately and compared with each other using their fingerprint vector, as shown in FIG. 5. These workloads are HLS-ified, which is a reduced C/C++ designed to be able to translate into RTL and has constraints such as requiring the upper bound of loops to be explicitly specified and the size of arrays to be determined prior to analysis. Features are extracted from the DFS subtrees to gauge the hardware specification based on these attributes.

In the process flow of FIG. 6, the methodology first extracts and clusters an AST of every workload of interest. For example, the source code is ingested and ASTs are generated. These ASTs are transformed to hardware-implementable formats by clustering to generate clustered ASTs (CASTs). A fingerprint vector (expanded at the top of FIG. 6) is extracted for every subtree in the workload. This dataset of fingerprints is fed into an ML model to identify potential matches between workloads. Note that while FIG. 6 shows both an unsupervised model and a supervised model being present in the process flow, in practical implementations the dataset of fingerprints may be fed into either ML model and not both. Thus, depending on the data available to the designer, the tool can be used with or without a pre-labeled dataset of matching subtrees.

The methodology has a pruning step to remove candidates that do not match and candidates that are predicted to have inefficient implementations. Tracking data dependencies is useful for pruning out inefficient designs. For example, because unsupervised ML approaches can have false positives, the matches are verified using sub-graph isomorphism. FIG. 5 also illustrates the extraction of data dependency, depicted by the curved arrow generally extending from node L2 to node V2. This dependency is classified by denoting where the producer and consumer are within the potential FFSA and code structure. This example shows that the producer and consumer are both in the FFSA, the direction is inward (inside the loop), and the loop is interleaved; however, there is no loop interval data dependency, no conditional dependency, and no index dependency, which means that the iterator is used as part of a computation operation (i.e., the size/type).

The fingerprinting methodology herein includes features that, when synthesized, translate into hardware or affect the hardware implementation. These include fingerprinting features and metrics used to gauge the structure of workloads. Table I shows an example of how the fingerprint vector is used to build CASTs and identify how code structures translate into hardware.

TABLE I

| Opcode | | | |
|---|---|---|---|
| Type | AST Statement | Reg Expression | CAST Node Name |
| 4*Loop | For(i=0;i<n;i++) | For,uOp:opr:val,BinOp:opr:int,bin:Opr,val,W* | Loop:For:I |
| | For(i=0;i<n;) i=add(i,1) | For,uOp:opr:val,BinOp:opr:int,bin:opr,val,W* | |
| | while | while,opr:w,binOp:opr:val,W8 | |
| 2*Compute | Binary | BinW*:int,W*:int, | BinOp: [symbol] Symbol¿ [symbol] oprnds¿ [symbol] oprnds¿ |
| Operation | Unary | UOp:W*:int | UnaryOp: [symbol] Symbol¿ [symbol] oprnds [symbol] |
| 5*Control | Function Call | FuncCall:W*returnStmnt | Branch:Call:Noret, Bt |
| | ret | with single Literal | Branch:Ret:singleLit |
| | ret | with Expression (a function or expression) | Branch:Ret:Exp |
| | if | without else statement (not implicit) | Branch:if:NoElse |
| | if | with else statement (implicit) | Branch:If:Else |
| 4*WildCard | declarations, | decl, Implicit, explicit, parenthesisStmnt | wildcard (W) node which will be |
| | initialization | | removed |

The following information is encoded in the footprint vector 504: a number of nodes, which approximates the size of the hardware kernel; a number of edges in each subtree, which is used to differentiate subtrees of similar size; density, defined as

$$\frac{NumEdges}{NumNode} ;$$

computational intensity (Ops) of each subtree, estimated by the percentage of nodes that are dedicated to operations, encoding binary and unary operations separately; operands, which tracks the percentage of the subtree's nodes that are arrays and variables normalized to the total number of nodes in the subtree, the size of all arrays in the MachSuite having been unified by tuning to the maximum array size in pairs of MachSuite workloads; control, which keeps track of the normalized number of loop statement nodes and a normalized number of function statement nodes in the subtree; and data dependency, which encodes the producer, consumer, direction, interleaved loop, loop interval dependency, whether a conditional statement exists, whether the loop interval is used as an index or as part of the computational operation, and the size of the variable in a vector. Where the data dependency is produced and consumed affects how the optimizations affect the hardware. It has been shown that when the data dependency is inside the acceleration candidate subtree, latency and resource usage are increased.

As shown in FIG. 6, a classification of data dependencies is used in postprocessing to prune maps and HLS optimizations that would create FFSAs that are significantly slower and larger than the sum of the corresponding distributed accelerators; these are considered to be “inefficient” FFSAs. The fingerprint vector encodes the producer, consumer, and type of data dependency, particularly read after write. Where the data dependency is produced and consumed affects how the optimizations affect the hardware. The producer can be either a parent node to the FFSA candidate, a sibling node, or the FFSA candidate itself. These cases are encoded with the value P for the Parent, S for the sibling, and SA for the FFSA candidate itself. The consumer can be either the FFSA candidate, a sibling node, or a node outside of the FFSA candidate. These cases are also encoded with P for the Parent, S for the sibling, and SA for the FFSA candidate itself. The direction can be inward (meaning the dependency is toward inside the FFSA candidate) or outward (from the FFSA candidate), and is encoded by an I or O, respectively. If the loops are interleaved, the level of the loops where the data dependency is happening is tracked. For example, if the data dependency happens in three interleaved loops, the value in this column would be 3. This value may be used to help prune optimizations. All of these elements are encoded into the vector.

A variety of features were studied to represent the tree structure and summarize synthesizable information from workloads. Features from the AST representation with minimal correlation with each other were chosen so that the information extracted from them is increased. The number of nodes is the most deterministic feature in finding similarities. The structure of the tree, in general, has a large effect on finding similarities between DFS subtrees. The number of binary and unary operations also has a large effect, but the effect is smaller than tree structure.

Finding Fixed Feature Shared Accelerators with Machine Learning

With a compact representation of a workload as described above, it is possible to use ML as a diagnostic test to detect potential matches. Either supervised or unsupervised methods, or both, may be used to design the tool. Unsupervised learning makes it possible to cluster similar subtrees and find FFSA candidates. Although the FFSA candidates may require verification, the technique has advantages where isomorphism results on even a subset of subtrees are not accessible. Furthermore, using a supervised ML such as Random Forest allows finding of similarities between workloads. Even though supervised learning relies on isomorphism, a methodology based on Random Forest Classification is accurate and, after training, can be used to find similarities between workloads without relying on isomorphism. Thus, for the following example, the result of supervised classification using Random Forest is discussed.

After generating a transformed AST for each DFS subtree, a post-processing script may be run to extract the statistical information of each subtree (see FIG. 5) and save its fingerprint vector. To illustrate the effectiveness of the methodology described herein, a random selection was then used to select training data and each experiment was repeated ten times.

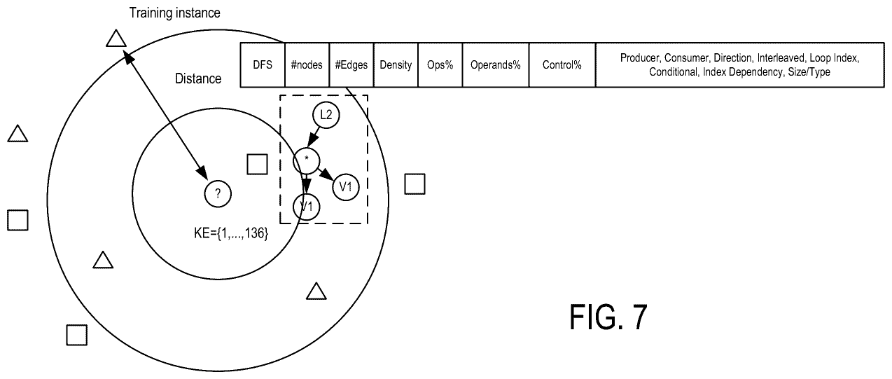

FIG. 7 illustrates an example of unsupervised classification. This approach was used to quickly assign labels to subtrees and check for accuracy. The use case of unsupervised learning may be, for example, when there is no isomorphism result to be used for training on the entire workloads or even a subset of it. An unsupervised approach provides acceptable results, at least because the dataset for this example is not complicated. Unsupervised clustering methods may facilitate FFSA design selection by clustering similar subtrees and selecting FFSA candidates without running the isomorphism beforehand. Both k-nearest neighbor (KNN) and kmeans were used for unsupervised learning in this example. However, in other examples nearest centroid classifier (NCC) may be used as a baseline classifier. For purposes of explanation, KNN is discussed in more detail below. The impact of different features on accuracy was studied, and the results are shown in Table II below. In Table II, the number of neighbors is kept constant at two.

TABLE II

| n_neighbors | Feature | accuracy | TP | FP | TN | FN |
|---|---|---|---|---|---|---|
| 2 | intOpr | 0.5 | 35.71 | 14.29 | 14.29 | 35.71 |
| 2 | BinOp | 0.57 | 42.86 | 14.29 | 14.29 | 28.57 |
| 2 | den | 1.0 | 71.43 | 0.0 | 28.57 | 0.0 |
| 2 | nEdge | 0.93 | 71.43 | 7.143 | 21.43 | 0.0 |
| 2 | forLoop | 0.71 | 71.43 | 28.57 | 0.0 | 0.0 |
| 2 | numParam | 0.64 | 42.86 | 7.14 | 21.43 | 28.57 |
| 2 | numUn | 0.79 | 71.43 | 21.43 | 7.143 | 0.0 |
| 2 | n1 | 0.93 | 71.43 | 7.143 | 21.43 | 0.0 |
| 2 | UnOp | 0.5 | 35.71 | 14.29 | 14.29 | 35.71 |

Table II shows that the number of nodes has the largest impact on accuracy. However, it was possible to achieve an accuracy of 100% with two neighbors at a 20% test size with a vector of [‘Unary Operation’, ‘Binary Operation’, ‘num Edge’] features.

Particularly for situations where the ground truth results from isomorphism are available, and the false positives and false negatives can therefore be known, unsupervised classification may be useful for quickly assigning labels to uncomplicated, broad land cover classes. KNN is a non-parametric classification method; different algorithms and different numbers of neighbors are swept. In particular, K was swept from 2 to 132, which was the total number of subtrees. The KD tree, ball tree, and brute force were used to create the data structure for the KNN model. To avoid over-fitting, the dataset was divided into training and test splits, which provides a better illustration of how the algorithm performs during the testing phase. The size of the training set was also swept from 10% to 90%. However, it was discovered that, as the number of neighbors K was increased, the number of false negatives and false positives increased substantially. For example, where K=4, the rate of false positives rose to 80%.

Table III shows how the absence of some of the characteristics affects the occurrence of false positives and negatives for the unsupervised KNN model. For example, if the number of parameters used in the operations is not accounted for, the rate of false negatives jumps to 100%. This means that, in order to reasonably cluster subtrees, these features should be considered.

TABLE III

| | False | False | reduced number |
|---|---|---|---|
| Metric | Negatives (%) | Positives (%) | of isomorphism |
| nodeNum | 75 | 0 | 27 |
| density | 75 | 0 | 45 |
| forLoop | 0 | 45 | 36 |
| numParam | 100 | 100 | 50 |
| BinaryOp | 79 | 0 | 55 |
| UnaryOp | 75 | 0 | 20 |
| PatternAlignment | 0 | 64 | 42 |

As noted above, supervised ML algorithms may also be used. Supervised ML is a subcategory of ML algorithms that use a labeled dataset for training. Each supervised ML algorithm has a set of characteristics that makes it suitable for a specific type of data. Support Vector Machine (SVM), Gradient boosting trees, and Random forest are examples of such algorithms.

In an example, Random Forest was used for the supervised learning implementations described here because the input data is tabular, suited for tree-based MLs; supervised machine learning provides an improvement over decision trees, reducing overfitting; compared to unsupervised implementations, false positives are lower; and a training set exists, from graph isomorphism. Random Forest is a hierarchical multistage supervised classifier. Hierarchical classification can consider both tree structural representative and workload characteristics. The dataset is large, but not necessarily complicated. Therefore, a method like SVM may take longer to train than Random Forest, and is neither necessary nor as efficient. Gradient boosting trees may be more accurate than Random Forest, but the dataset used here does not have a complex pattern and is not noisy, so the increased accuracy is unnecessary. Note that, while false positives do not violate isomorphism results, they may still result in the implementation of unnecessary FFSAs.

Isomorphism has a transitive property. Because clustered representations of ASTs (i.e., CASTs) are used, each node represents a distinct operation. This will cluster all subtrees into different distinctive clusters of matched trees. All subtrees in each of these clusters is given a unique label. This unique label is then added to the fingerprinting vector of each subtree, which will be used later for training purposes and later for calculating accuracy.

To label the dataset for supervised classification, the results from graph isomorphism were used. Each subtree of nodes is assigned a unique identifier, which is then incorporated into the fingerprinting vector of every subtree. These labels play a role in training and subsequently calculating accuracy. There are 804 isomorphic DFS subtrees in the database of MachSuite trees used for this analysis. A Python script was applied that uses isomorphic tree match to label them. Applying isomorphism to subtrees creates equivalence classes. The subtrees in these equivalence classes our reflective, symmetric, and transitive. The isomorphism used here is based on the synthesizable features of the tree representation. Thus, in the experiments discussed here, applying isomorphism to CASTs resulted in 71 categories of subtrees, each of which has a unique identifier. The supervised ML model predicts whether a subtree belongs to an equivalence class. All hyperparameters in the ML model and the size of the test population were swept. Confusion matrices were present for each configuration. While the non-normalized (to the size of the testing vector) values are different, nominal false positives and negatives are shown in the smallest size of testing vectors.

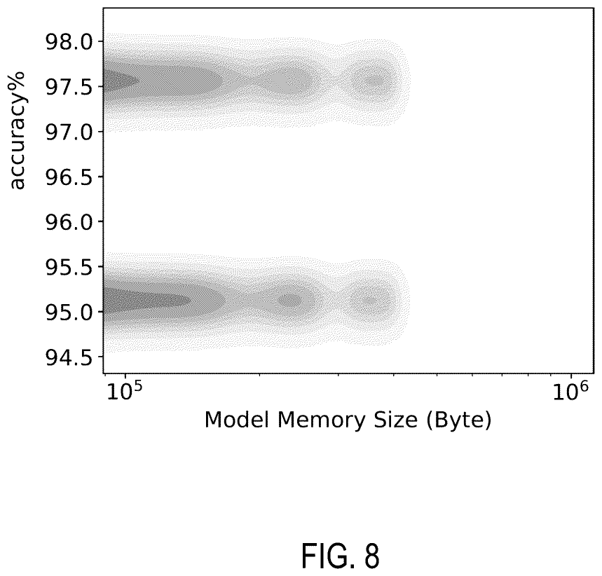

Hyperparameters are parameters that are set before the training and will affect the model's size and accuracy. Tuning these parameters may be used for finding an accurate model. FIG. 8 illustrates the relationship between a Random Forest model's accuracy and hyperparameters. The highest accuracy can be achieved with many combinations of hyperparameters and does not require a large memory usage. In this example, memory usage is estimated by the depth of trees in the Random Forest methodology. Sweeping all the parameters as illustrated in FIG. 8, the hyperparameters for Random Forest, their range, and their final value for tuning are illustrated in Table IV.

TABLE IV

| | | | Tuning |
|---|---|---|---|
| Hyperparameter | Description | Range | Value |
| Training Set Size | 995 Tree subtree-representation | 10-100% | 50% |
| Random State | Controls shuffling | [1, 10] | True for |
| | | | multiple |
| | | | values |
| Max Depth | Depth of RandomForest's | [1, 7] | 6 |
| | decision trees | | |
| Number of | Size of RandomForest's decision | [5, 35] | 25 |
| Estimators | trees | | |
| Min Samples | Minimum number of samples | [2, 10] | 6 |
| Split | required to split an internal node | | |
| Min Samples | Minimum number of samples | [2, 10] | 4 |
| Leaf | required to be at leaf node | | |
| Bootstrap | Whether bootstraps samples are | True/ | True |
| | used when building trees or not | False | |

The smallest model with 97% accuracy has 25 nodes and a maximum depth of 6 for the decision trees. These hyperparameters affect the shape and number of decision trees. The shape of the tree, in turn, determines the size of the model. As can be seen from Table III, the hyperparameters of max depth and number of estimators/trees together define the size of the model, and are among the important factors. The experimental verification was performed keeping the bootstrap value true, and min samples split and leaf affect the overfitting and accuracy of the model. Increasing the maximum leaf setting would reduce false positives from 5.8% to 1.4% and elevate true negatives from 32% to 36%. False negatives were consistently at 0, except in cases where, with 5 trees, the maximum depth was 6, the minimum split was 2, and the minimum sample leaf was either 2 or 4. Eliminating false negatives permits the methodology of the present disclosure to be used as an early-stage diagnostic test. This implies an accurate model within a 10K byte size, achieved in approximately 383 s of training.

### Results

The fingerprinting methodology was evaluated first by measuring the accuracy and speedup compared to the subgraph-isomorphism approach of the comparative example. The MachSuite benchmark suite for accelerator-based applications was used. These applications range from signal processing basic math and linear algebra. All workloads for MachSuite were written in HLS-compatible C code, with all of the array size and upper loop bounds predetermined; namely, they followed the suggested syntax and structure in the Xilinx HLS manual. Additionally, there are no in-line functions, and the size of the arrays is fixed.

In comparing the fingerprinting approach with the comparative example, early-stage fingerprinting was viewed as a diagnostic test. That is, it should accurately narrow the design space but not leave any potential candidates behind that the more computational approach (the comparative example) would have identified. Two metrics were used for accuracy: false positives and false negatives. “False positives” refers to the number of incorrectly identified isomorphic subtrees. In the approach described herein, the rate of false positives was reduced by categorizing nodes based on their hardware equivalency by selecting features in the fingerprint. “False negatives” refers to instances where the methodology misses a potential match by indicating that two subtrees are not isomorphic when they are. To evaluate similarities between more than two workloads, a transitive law was applied to combine a list of all isomorphic subtrees, and this list was then used to estimate the false positives and negatives.

To determine the speedup compared to isomorphism, unsupervised and supervised classification was compared with isomorphism, and tree-isomorphism was used to calculate the error margins of the ML fingerprinting methodology described herein. The front-end of the LLVM-clang version 3.7.0 was used for the static analysis suite. Clang was used to generate the ASTs. Then, a DFS function was written in Python to break the ASTs into all the DFS subtrees. The Networkx package implementation of the VF2 isomorphism algorithm was used to find the isomorphic subtrees. The time complexity of the two approaches was calculated by running the scripts on a server with an Intel(R) Xeon(R) CPU E5-4627 v4 @ 2.60 GHz, cache size 25600 kB, with 10 CPU cores. The scripts were timed with all data and ML algorithms on the local hard disk of the server.

Each workload in MachSuite was compared with all other workloads in the suite using the fingerprinting methodology. The tool finds the largest isomorphic subtrees between workloads, ensuring good coverage with little hardware overhead. In one test, FFSAs covering two workloads (FFSA2) were compared to FFSAs covering four workloads (FFSA4). More than 4000 FFSA4s and 10000 FFSA2s were designed, including unique implementations and HLS optimizations. A subset of results are shown where the shared part of FFSA4 is different from FFSA2; the selected shared accelerator has no loop iteration data dependency, which cut down the selection to about 2700 accelerators between 6 workloads.

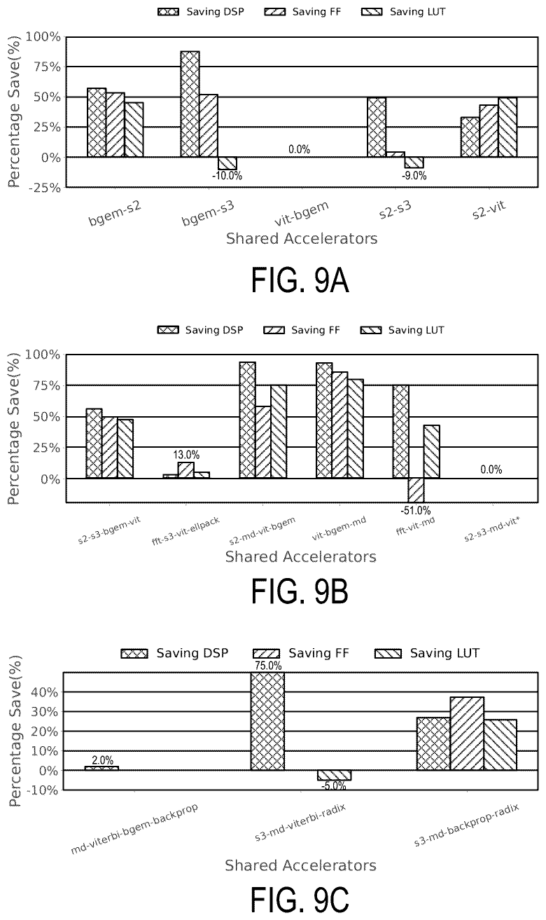

FIGS. 9A-C shows a subset of these accelerators. In FIGS. 9A-C, each accelerator name represents the workloads covered by the accelerator. For example, it is possible to compare the S2-S3-Vit-BB FFSA4 with the two S2-S3 and Vit-BB FFSA2s. Note that there can be multiple instances of FFSA2s between two workloads. However, that chance decreases with FFSA4s. For example, S2-S3-BB-Vit has a shared core of (DSP: 4, FF: 6, LUT: 6), and S2-S3 has (DSP: 1, FF: 21, LUT: 77) and BB-Vit has (DSP: 16, FF: 24, LUT: 4). The FFSA4, in this case, saves 48% on digital signal processors (DSPs), 47% on flip-flips (FFs), and 63% on lookup tables (LUTs) compared to the two FFSA2s. This range depends on the size of the FFSA4 and FFSA2's shared accelerator. Cases were found for which, depending on the optimization method and the original size of the FFSA2s, building an FFSA4 would not be practical. These results are also shown in Table V.

TABLE V

| | Detection with RF | | | | |
|---|---|---|---|---|---|
| | Speedup compared | Static | Dynamic | Number | Latency |
| SA2 | to iso (×10⁶) | Coverage % | Time % | of Maps | (DA/SA) |
| bgem-sten2 | 5 | 28 | 99 | 1 | 1.22 |
| sten3-bgem | 6 | 14 | 94 | 3 | 1 |
| vit-bgem | 4.8 | 34 | 99 | 4 | 2.2 |
| sten2-sten3 | 5.9 | 12 | 99 | 2 | 1.17 |
| sten2-vit | 3.5 | 10 | 18 | 1 | 2.97 |

FIGS. 9A-C show estimated FFSA4s and FFSA2s, and show the resource consumption and latency compared to the sum of the best-performing distributed accelerator with the smallest footprint. The size of each FFSA was estimated by implementing the shared core and the rest of the code for each workload. The shared area was added once, as shown in FIG. 9A. For latency, Vivado HLS from Xilinx/AMD was used to calculate the latency of the unique part of the workload and the shared part, and the two were added with the consideration of one cycle communication between the unique and shared accelerators as well as the latency of the shared accelerator and how many times it has been called.

Accuracy was good for many combinations of hyperparameters in Random Forest; for example, the smallest models on a training set of 50% was 5 trees, max d of 4, min sample leaf of 2, and min sample split of 6 had 97.5% accuracy using the ML model. In this example, the training set and test set have the same value, which means overfitting is not seen. These models may be used to find an FFSA2 faster, increase workload coverage of an FFSA (e.g., design FFSA3s and FFSA4s), and/or find similarities in new workloads. The fingerprinting methodology allows achievement of things that were not possible without the methodology. It provides a significant speed increase relative to the comparative example while retaining accuracy (e.g., about 98% accuracy). This increase is discussed below, followed by a discussion of how speeding up FFSA detection affects finding an FFSA2 and implementing some of the FFSA2 in hardware. Then, possible methods for increasing the coverage of each accelerator by designing FFSA3s and FFSA4s are discussed. Finally, methods for applying fingerprinting to new applications are shown, which provide results faster than isomorphism (and in some cases, provide results that isomorphism was unable to finish in over three months). Thus, the present disclosure provides an early-stage design tool to detect possible FFSA candidates.

To show this, an experimental analysis was performed. As above, the front-end of the LLVM-clang version 3.7.0 was used for the static analysis suite. Clang was used to generate the ASTs, and a DFS function was written in Python to break the ASTs into all the DFS subtrees. For the analyzed workloads of MachSuite, 137 DFS subtrees were present. Isomorphic subtrees were found using Networkx package's implementation of the VF2 isomorphism algorithm. The time complexity of the two approaches was calculated by running the scripts on an Intel(R) Xeon(R) CPU E5-4627 at 2.6 GHz with 32K L1 and 256K L2 cache. Observations were made by running each experiment 10 times and averaging the experiment's execution time. It was noted that, on average, preprocessing the CASTs to make the fingerprint vector for each DFS (a one time task) took about 83.1% of experimental time, sweeps took about 13%, and finding false negatives and positives took less than 0.1%.

FIG. 4 shows that isomorphism, on average, takes 10³ times longer to find all pairs of similarities between workloads. Supervised classification was compared with isomorphism, and tree-isomorphism was used to calculate the error margins of the ML approach of the present disclosure. As can be seen in Table V, Random Forest increases the speed of FFSA detection by a factor of about 5×10³. These shared subtrees have a variety of characteristics, but as long as the majority of the dynamic time is spent in that part of the code, the FFSA has comparable performance characteristics. Acceleration candidates may be chosen that are in the hot-code. The static coverage compares the size of the Map's CAST (the transformed clustered AST) to the size of the workload's CAST. The “number of maps” column shows how repeating smaller maps multiple times in work workload affects the FFSA's speed increase.

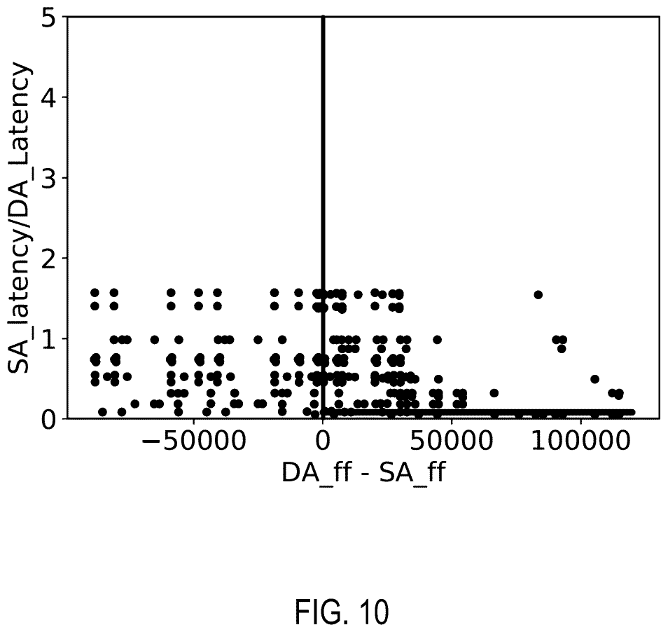

The comparative example exhaustively finds SAs and compares inefficient vs efficient SA characteristics. One of the main characteristics of an efficient shared accelerator was for the shared-subtree to be in the hot-code, which was difficult given that about 4000 FFSA2 candidates were present in total. For the comparative example, FFSA2s with the shortest latency were selected and compared to the distributed accelerators with the best performance and smaller footprint. Further, the analysis was narrowed to four FFSAs with 90% dynamic time, and one case of low dynamic time coverage was included to show contrast. Empirical optimizations were applied from a set of 19 to 25 standard optimizations to each workload. From this set, the configuration that gave the best latency and lowest footprint was selected. These FFSAs were compared to different combinations of optimizations applied to the corresponding distributed accelerators. The results are shown in FIG. 10. The Pareto curve is shown as a thick black line, and shows that the efficient FFSAs are comparatively few relative to all possible FFSAs designed. In FIG. 10, the y-axis shows the speed increase of FFSAs relative to the distributed accelerator, and the x-axis shows the difference between the distributed accelerator's FF usage and the FFSA's FF usage. Together, FIG. 10 shows the effect of creating FFSAs in view of the time to implement a distributed accelerator for each workload. The more positive the x-value of a point, the more desirable it is because it shows that, for the particular optimization, the sum of the distributed accelerators uses more resources than the FFSA. Note that, in FIG. 10, there are no data points in the x-axis range of (−1000, 1000). Unlike isomorphism, which failed to find similarities between some workloads, the fingerprinting methodology described herein found similarities between all workloads in a maximum of 400 ms. It as possible to find the same FFSAs using the fingerprinting vector. The FFSAs were implemented in HLS by using a top function that would switch between two workloads and have a shared function between the workloads.

As noted above, FIGS. 9A-C shows the resource usage of FFSAs in comparison to the “best” distributed accelerator, and Table IV summarizes the accelerator characteristics, including the dynamic coverage and slowdown compared to distributed accelerators. Each accelerator name represents the workloads covered by the accelerator. The FFSA which covers only 18% of dynamic time has the largest latency slowdown. The FFSA2 for stencil2d-viterbi shows an increase in latency compared to the distributed accelerator. Note that this comparison uses the longest latency workload and input pattern of the FFSA, compared to the longest latency of the distributed accelerator. The viterbi-bbgemm FFSA is a case of one shared accelerator having multiple instances in the workload; in this case, the communication overhead may outweigh the saved resources of the FFSA. The FFSA for bbgemm-stencil2d has one large shared subtree in the hot-code, and has a slight slowdown compared to the DA with the longest latency. Both bbgemm-stencil3d and stencil2d-stencil3d use some extra LUTs (less than 10%) and have similar latency compared to the corresponding distributed accelerator. Table V also compares Random Forest time and their speedup compared to isomorphism.

FIGS. 9A-C illustrate the results after pruning accelerator candidates using data dependency. The latency in these FFSAs remains the same as their corresponding distributed accelerators. Each bar in FIGS. 9A-C shows how much area it has saved or whether the sum of two distributed accelerators is the same as an FFSA. These cases are for the smallest shared map, which was repeated multiple times. In the case of vit-bbgemm the shared map was too small and in interleaved loops.

FIG. 9C shows FFSA4s that were found using the fingerprinting methodology of the present disclosure and not isomorphism. In these cases, the isomorphism script was stopped because it took too much time. As can be seen, stencil3d-MD-backprop-radix exhibits a slowdown of 20% compared to the distributed accelerator, but it significantly saves on Block RAM (BRAM), DSPs, FFs, and LUTs. The MD-viterbi-gemmNcu-backprop FFSA maintains latency similar to its corresponding distributed accelerator, but the area usage increases for every FPGA resource.

Because the computation has a large number of similarities, stencil3d-MD-viterbi-radix reduces the amount of DSP resources. DSPSs are also the most valuable resource on FPGAs. The latency of the FFSA remains the same as the distributed accelerator, but because of the scheduling of shared resources to accommodate the data dependency inside the FFSA, more LUTs and FFs were used. The map between MD-viterbi-bbgemm-backprop is too small, and therefore the savings between these workloads are minimal. In stencil3d-MD-backprop-radix, there are also different directions of data dependencies, which results in extra resources in FF. This is why the savings on FFs goes to zero. In this case, there is also a dependency inside the shared accelerator. Therefore, to facilitate the scheduling of resources, more LUTs have been used as well.

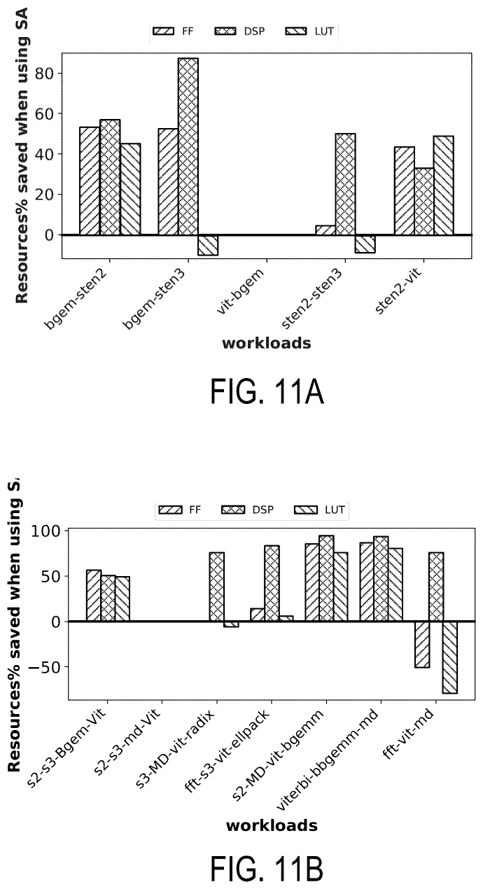

Isomorphism can find similarities between pairs of workloads at each time. By finding similarities between multiple workloads in a speedy and efficient manner and designing hardware cores for the shared part, it is possible to increase the workload coverage of each accelerator. FIG. 11B and Table VI show the results of FFSA3s and FFSA4s designed according to the present disclosure. Table VI shows that only 2 FFSA3s, viterbi-bbgemm-md and fft-vit-md, have a speed decrease, and all the FFSAs used similar or fewer DSPs. It can be seen that fft-bit-md has a SA-SA-I-d-d-d-N-d data dependency, which would worsen the FF and LUT usage because the loop iterator is used in computation inside the loop. Each workload was compared in MachSuite with all other workloads in the suite using the fingerprinting methodology. The tool finds the largest isomorphic subtrees between workloads, resulting in improved coverage with little hardware overhead. In this experimental analysis, more than 250 FFSA4s, 45 FFSA3s, and their corresponding distributed accelerators were designed.

TABLE VI

| | saving | saving | saving | latency |
|---|---|---|---|---|
| FFSAs | DSP % | FF % | LUT % | (DA/SA) |
| s2-s3-bgem-vit | 56 | 50 | 48 | 1 |
| fft-s3-vit-ellpack | 3 | 13 | 5 | 1 |
| s2-md-vit-bgem | 94 | 58 | 75 | 1 |
| vit-bgem-md | 93 | 86 | 80 | 0.85 |
| fft-vit-md | 75 | −51 | 43 | 0.72 |
| s2-s3-md-vit* | 0 | 0 | 0 | 1 |

Most methodologies based on isomorphism have an np-hard computational complexity. Some of the benchmarks in MachSuite have a larger number of nodes. Table VII shows the number of nodes for each workload in MachSuite. A subset of these accelerators are shown in Table VIII, which shows FFSAs that cover backprop, Radix, and gemmNcu. The only FFSA4 that had a slowdown compared to the distributed accelerator was stencil3D-MD-backprop-radix, but it provides significant savings on BRAM, DSP, FFT, and LUT usage. Note that MD-viterbi-gemmNcu-backprop had the same latency as the corresponding distributed accelerator, but the area usage has increased for every resource on the FPGA.

TABLE VII

| workload | number of nodes |
|---|---|
| AES | 3605 |
| backprop | 1076 |
| bfs-bulk | 54 |
| bfs-queue | 84 |
| fft-striped | 92 |
| fft-transpose | 3876 |
| bbgemm | 142 |
| gemmNbcu | 71 |
| nw | 188 |
| md-knn | 683 |
| md-grid | 222 |
| spmvE | 53 |
| spmvCRS | 22 |
| stencil2d | 169 |
| stencil3d | 499 |
| viterbi | 199 |
| sortRadix | 6816 |
| sortGrid | 172 |

TABLE VIII

| | | | | | | Latency |
|---|---|---|---|---|---|---|
| FFSA/DA | BRAM % | DSP % | FF % | LUT % | URAM % | (DA/SA) |
| MD-viterbi-bbgemm- | 0 | 2 | 0.3 | 0.01 | 0 | 1 |
| backprop | | | | | | |
| sten3d-MD-viterbi-radix | 0 | 75 | 0 | −5 | 0 | 1 |
| sten-3d-MD-backprop- | 13 | 27 | 37 | 26 | 0 | 0.8 |
| radix | | | | | | |

The isomorphism scripts were run on workload trees for two months. The scripts did not finish and did not find similarities on some of the workloads in MachSuite. In contrast, the fingerprinting methodology may be used to find shared maps between workloads that were too large for the comparative isomorphism approach. In particular, AES, backprop, fft-transpose, merge sort, and radix sort are discussed here. The working libraries for these workloads were added, as well as the source code. To create the CAST, first all white-space nodes were removed. Then, starting from the root's leftmost child, the dfs of every node from the bfs traverse was analyzed. Each workload was broken down to all its DFS traverses, and was saved in a different dotfile. These dotfiles were the input to the script that extracts the fingerprint for each file. The fingerprint for each file was extracted and the file was appended to the other workloads.

With regard to AES, the fingerprinting methodology of the present disclosure did not find similarities. This may be because AES is based on bitwise operations that are not repeated in other workloads. The function FFT-transpose is three computational lines in a loop. Because the number of operands in these computational operations are not similar to other workloads, the comparative example did not find any similarities. However, by removing the number of operands from the vector, the fingerprinting methodology was able to find these similarities. The merge sort function includes a merge algorithm that is mostly based on array partitioning. While the fingerprinting methodology found these similarities, it found that the shared maps were too small for an efficient shared accelerator. Finally, Table VIII above shows some of the implementations of FFSAs that the fingerprinting methodology found with the Radix workload. It shows that finding the smallest instance and inlining all the instances would improve the overall area usage. Whereas the isomorphism approach was unable to computationally handle certain functions (and was thus unable to even determine that no similarities existed), the fingerprinting methodology properly found a lack of similarity.

### Finding Larger Maps by Estimation

Finding larger FFSAs relies on understanding the cost of differences and graph transformations of workloads. This happens when a sub-subgraph is isomorphic, but the larger subtree has some differences. In this case, adding elements to the smaller subtree and changes to the characteristics would allow the design of larger FFSAs. Larger FFSAs that originally were not isomorphic would allow a reduction in the communication cost. To do so, a large-scope behavioral study was performed on the effect of conditional, computational, and control statements. Data types, array size, number of inputs, and level of interleaved loop, as well as type and placement of conditional statements, were studied. For each of these cases, types of data dependency and different optimizations were considered.

Similar computations can be detected across different benchmarks. However, some of these benchmarks have different data types. The preliminary experiments show that different data types have different resource usage, but that the resource usage is within the same percentage of usage. To address this, it is possible to either use a more complicated data structure or to plan to lose accuracy or use extra resources by changing the data type in the program's source code. A subset of the experiments are shown in Table IX, which shows that float and a reduced 6-bit representation of integer (integer 5) has the same latency. However, the resource usage of float is 10× more than on int5. These are some of the considerations that will be implemented for a cost function.

TABLE IX

| DataType | Latency # of Cycle | FF | DSP | LUT |
|---|---|---|---|---|
| Double | 21 | 11 | 3039 | 4108 |
| Float | 9 | 5 | 819 | 1118 |
| int5 | 9 | 0 | 92 | 112 |

In the designs, cases of full similarity were searched for. To increase the size of maps, the maps were padded so that they had similar computation and footprint. Padding was explored in two categories: padding computational operations and padding conditionals. For padding computational operations, computations were added so that the subtree would look the same for both workloads and numerical parameters were used to reconfigure operations for each workload. For example, 0 was used for add and 1 for multiplication, so that the final output would not change. For padding conditionals, with the same approach of reconfigurability based on the inputs, the conditional statements were included in the FFSA function, and inputs were used to skip the statements. Table X shows an example case for a preliminary design in which padding was attempted. In this case, a loop was added to a previously only computation. The following parameters were considered for padding the AST representation: the location of computations, the type of computations, the number of computations, the number of loops, whether the loops are interleaved or not, size of input, type of input, and data dependency types.

TABLE X

| FFSA | BRAM | DSP | FF | LUT | URAM | Max Latency |
|---|---|---|---|---|---|---|
| 2Add in a loop | 0 | 0 | 2 | 15 | 0 | 1 |
| DA-1 Add and Mul in Loop | 0 | 14 | 1036 | 1816 | 0 | 40 |

Another way to increase the size of maps is to include loops in the FFSA. In some implementations, however, the upper bounds of loops are different. Control statements and whether loops affect resource usage and latency. The HLS requires programs to specify upper bounds of loops before compilation. This means that a designer has two options for the FFSA function: whether to add a conditional and disregard the additional computation for the function with a smaller upper bound, or to add another function that completes the computation for the function with a higher upper bound. In this example, the former is implemented. However, the type of data flow affects the size of the map greatly. Table XI shows some of the cases that were studied regarding the conditionals and their relations to the hot-code that can be accelerated using a shared function to create an FFSA.

TABLE XI

| | FFSA | Extra | lowest | highest | | | | | |
|---|---|---|---|---|---|---|---|---|---|
| Type | or DA | Dependency | latency | latency | BRAM | DSP | FF | LUT | URAM |
| if-In- | SA | No(WAR) | 1 | 39 | 0 | 14 | 1036 | 1816 | 0 |
| loop | | indexD | | | | | | | |
| if-else | DA | NoDD | 1 | 39 | 0 | 14 | 1036 | 1816 | 0 |
| out of | | | | | | | | | |
| loop | | | | | | | | | |

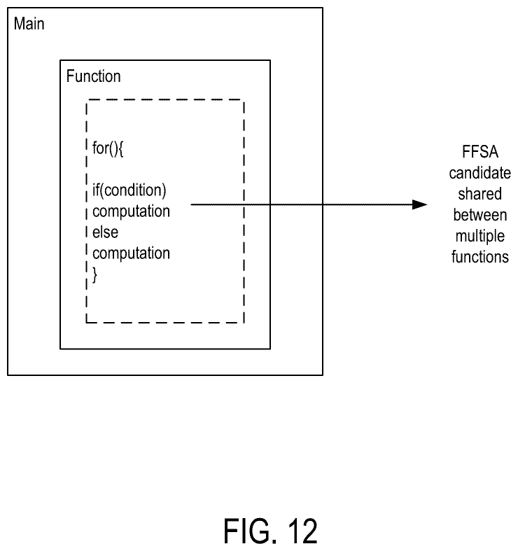

FIG. 12 illustrates a baseline for studying conditional statements and their effect on both FFSA and distributed accelerator implementation, and shows the general view of a subset of the experiments. The position of the conditional matters, especially when optimizations are applied to it. Table XI shows that, in the base case (with no optimizations applied), the size and latency of whether the conditions are in or out of the loop is similar for the same type of conditional statement and identical input for the conditional statement. Loop unrolling and loop pipelining, in addition to inlining to the functions for FFSA candidates, affects the numbers shown in Table XI.

### Example Implementations

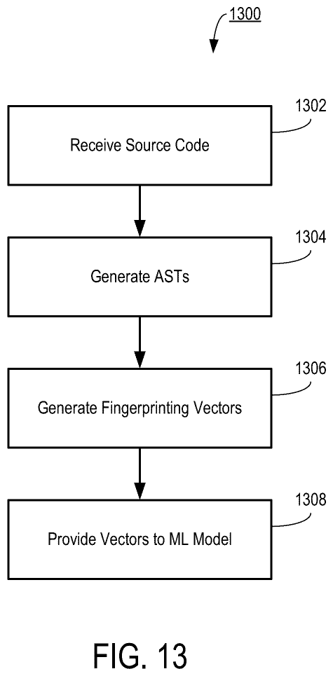

Finding similarities between workloads can be done either at the software or hardware level. FIG. 13 illustrates an example of a method 1300, implemented either as software or hardware routines, for generating shared accelerators.

The method 1300 beings with an operation 1302 of receiving a set of source code. The source code may indicate a plurality of workloads to be performed by an electronic circuit (e.g., an SoC). Based on the source code, at operation 1304 the method includes generating a plurality of ASTs. The ASTs may represent the source code as a tree including a plurality of nodes corresponding to function instructions, and a plurality of edges corresponding to the hierarchy of program instructions. Operation 1304 may include parsing the source code to generate the AST representations. In some implementations, operation 1304 may further include clustering the ASTs to generate one or more CASTs.

The ASTs (either directly or, where present, indirectly through the CAST(s)) may then be used at operation 1306 to generate a plurality of fingerprinting vectors corresponding to the plurality of ASTs. A fingerprinting vector may encode at least one of a number of nodes, a number of edges, a density, a computation intensity, an operands percentage, a control, or a data dependency. For example, a fingerprinting vector may have a form as shown in FIGS. 5-6 and described in detail above.

At operation 1308, the fingerprinting vectors may be provided to an ML model. The ML model may be configured to predict similarities between different ones of the plurality of workloads (e.g., by analyzing the information encoded in the vectors), and to output one or more candidate FFSAs based on the prediction. The ML model may be an unsupervised ML model (e.g., a KNN model, a NCC model etc.) or a supervised ML model. If the ML model is an unsupervised ML model, operation 1308 may include verifying an output of the ML model, for example using graph isomorphism. If the ML model is a supervised ML model, the ML model may be trained (i.e., may have been trained) using a set of labeled training data generated by, for example, graph isomorphism.

The output of the ML model may be used to generate a design for the electronic circuit, the design including at least one FFSA based on the at least one candidate FFSA. The design may be an FFSA2 design, an FFSA3 design, an FFSA4 design, or a higher order (FFSA5+) design. Thus, the design may include dedicated hardware kernels corresponding to hardware that is unique to workloads and a shared hardware kernel corresponding to hardware that is common to the workloads.

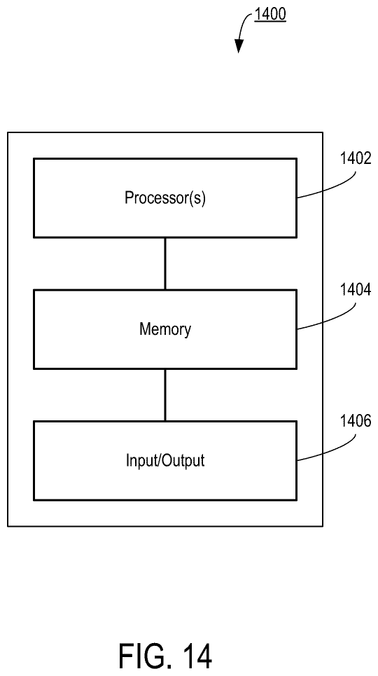

The method 1300 of FIG. 13 may be performed by a FFSA generation system. FIG. 14 illustrates one example of such a system 1400. The system 1400 includes at least one electronic processor 1402, a memory 1404 operatively connected to the at least one electronic processor 1402, and an I/O 1406 operatively connected to the memory 1404. The at least one electronic processor 1402, the memory 1404, and the I/O 1406 may be configured to communicate with one another by, for example, a bus.

The memory 1404 may be configured to store instructions that, when executed by the at least one electronic processor 1402, cause the system 1400 to perform a series of operations, such as the operations making up the method 1300. In this regard, in implementations where the at least one electronic processor 1402 includes a plurality of individual processing units and/or processing cores, the processing units and/or cores may be configured to collectively and/or individually perform the operations of the method 1300 according to any combination, in serial, in parallel, or in combinations thereof. In some implementations, the memory 1404 may further store instructions corresponding to the ML model. In other implementations, however, the ML model may be remotely located (e.g., cloud-based), such that the system 1400 is configured to communicate with (i.e., provide input to and/or receive output from) the ML model.

Thus, the systems and methods set forth herein provide advantages over the comparative examples. In some situations, the graph comparison in the comparative example never finished; however, the fingerprinting methodology of the present disclosure does not have the same limitations. The fingerprinting methodology makes detecting shared accelerators more scalable and feasible. By implementing systems and methods according to the present disclosure, computational processes may be sped up by seven orders of magnitude or more relative to the comparative examples. The resulting FFSA candidates share application specific hardware, achieving a 93% accuracy for supervised classification and up to 97% accuracy for unsupervised classification, compared to isomorphism results. Running subgraph isomorphism on a test benchmark suite resulted in 80% fewer graph comparisons and a two order-of-magnitude speedup. It is also possible to detect and design FFSAs without running isomorphism on them first.

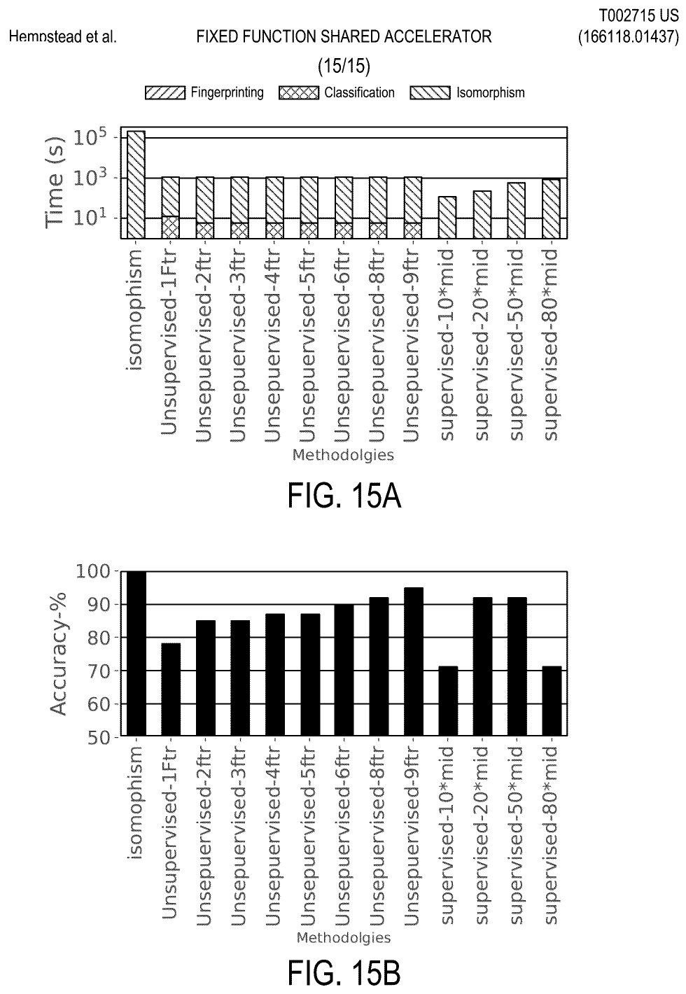

FIGS. 15A-B illustrate a comparison between computational time and accuracy. The time to verify that two subtrees are truly matches using subtree-isomorphism (considered as “ground truth”) and verification time were accounted for. For unsupervised implementations, the data includes two neighbors and the features' vector lengths are swept. For supervised implementations, the data includes the accuracy based on the training set size. Running subtree-isomorphism takes over 2250000 s of computation time on 804 subtrees in the 12 workloads. The fingerprinting of all trees is a constant, and it takes about 0.74 s, which is too small to be perceptible in FIG. 15A. The time to run classification includes the time of classification and calculating false positives and negatives. Unsupervised classification takes a maximum of 6.6 s for cases with 1 feature, while the time to calculate false positives, false negatives, and accuracy is about 5 s. The verification time is the median time to run isomorphism between two subtrees multiplied by the number of subtrees. For supervised implementations, the classification only takes 0.129 s, but the time is mainly spent in labeling the data, which depends on the training size. The smaller the training size, the less time is spent, but accuracy suffers. A 20% training set size gives an acceptable accuracy and improves the time by 10²×. The implementation of FFSAs in High-Level Synthesis (HLS) involved a top function that toggles between two workloads, incorporating a shared function between them

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of generating fixed function shared accelerators (FFSAs), the method comprising:
receiving source code, the source code indicating a plurality of workloads to be performed by an electronic circuit;
generating a plurality of abstract syntax trees (ASTs) based on the source code, wherein respective ones of the plurality of ASTs include a plurality of nodes correspond to function instructions;
generating a plurality of fingerprinting vectors corresponding to the plurality of ASTs, wherein respective ones of the plurality of fingerprinting vectors encode at least one of a number of nodes, a number of edges, a density, a computation intensity, an operands percentage, a control, or a data dependency; and
providing the plurality of fingerprinting vectors to a machine learning (ML) model, wherein the ML model is configured to predict similarities between different ones of the plurality of workloads and to output at least one candidate FFSA.

2. The method of claim 1, further comprising generating a design for the electronic circuit to include at least one FFSA based on the at least one candidate FFSA.

3. The method of claim 1, wherein the design for the electronic circuit includes a first dedicated hardware kernel corresponding to hardware that is unique to a first workload of the plurality of workloads, a second dedicated hardware kernel corresponding to hardware that is unique to a second workload of the plurality of workloads, and a shared hardware kernel corresponding to hardware that is common to the first workload and the second workload.

4. The method of claim 3, wherein the design for the electronic circuit includes a third dedicated hardware kernel corresponding to hardware that is unique to a third workload of the plurality of workloads, and the shared hardware kernel further corresponds to hardware that is common to the first workload, the second workload, and the third workload.

5. The method of claim 4, wherein the design for the electronic circuit includes a fourth dedicated hardware kernel corresponding to hardware that is unique to a fourth workload of the plurality of workloads, and the shared hardware kernel further corresponds to hardware that is common to the first workload, the second workload, the third workload, and the fourth workload.

6. The method of claim 1, wherein the ML model is an unsupervised ML classification model.

7. The method of claim 6, wherein the unsupervised ML classification model is at least one of a k-nearest neighbors (KNN) model or a nearest centroid classifier (NCC) model.

8. The method of claim 6, further comprising verifying an output of the ML model using a set of results generated by graph isomorphism.

9. The method of claim 1, wherein the ML model is a supervised ML classification model.

10. The method of claim 9, wherein the ML model has been trained using a set of labeled training results generated by graph isomorphism.

11. A system for generating fixed function shared accelerators (FFSAs), the system comprising:
at least one electronic processor;
a memory operatively connected to the at least one electronic processor, the memory storing instructions that, when executed by the at least one electronic processor, cause the system to perform operations including:
receiving source code, the source code indicating a plurality of workloads to be performed by an electronic circuit,
generating a plurality of abstract syntax trees (ASTs) based on the source code, wherein respective ones of the plurality of ASTs include a plurality of nodes correspond to function instructions,
generating a plurality of fingerprinting vectors corresponding to the plurality of ASTs, wherein respective ones of the plurality of fingerprinting vectors encode at least one of a number of nodes, a number of edges, a density, a computation intensity, an operands percentage, a control, or a data dependency, and
providing the plurality of fingerprinting vectors to a machine learning (ML) model, wherein the ML model is configured to predict similarities between different ones of the plurality of workloads and to output at least one candidate FFSA.

12. The system of claim 11, the operations further including generating a design for the electronic circuit to include at least one FFSA based on the at least one candidate FFSA.

13. The system of claim 11, wherein the design for the electronic circuit includes a first dedicated hardware kernel corresponding to hardware that is unique to a first workload of the plurality of workloads, a second dedicated hardware kernel corresponding to hardware that is unique to a second workload of the plurality of workloads, and a shared hardware kernel corresponding to hardware that is common to the first workload and the second workload.

14. The system of claim 13, wherein the design for the electronic circuit includes a third dedicated hardware kernel corresponding to hardware that is unique to a third workload of the plurality of workloads, and the shared hardware kernel further corresponds to hardware that is common to the first workload, the second workload, and the third workload.

15. The system of claim 14, wherein the design for the electronic circuit includes a fourth dedicated hardware kernel corresponding to hardware that is unique to a fourth workload of the plurality of workloads, and the shared hardware kernel further corresponds to hardware that is common to the first workload, the second workload, the third workload, and the fourth workload.

16. The system of claim 11, wherein the ML model is an unsupervised ML classification model.

17. The system of claim 16, wherein the unsupervised ML classification model is at least one of a k-nearest neighbors (KNN) model or a nearest centroid classifier (NCC) model.

18. The system of claim 16, the operations further including verifying an output of the ML model using a set of results generated by graph isomorphism.

19. The system of claim 11, wherein the ML model is a supervised ML classification model.

20. The system of claim 19, wherein the ML model has been trained using a set of labeled training results generated by graph isomorphism.
